(19) United States
(12) Patent Application Publication
(10) Pub. No.: US 2003/0043009 A1
(43) Pub. Date: Mar. 6, 2003

(54) Multiple concentric coil wattage converter

(76) Inventor: Edward Chow, Vancouver (CA)

Correspondence Address: EDWARD CHOW, 1009 W. 47TH AVENUE, VANCOUVER, BC, V6M 2L3, CA

(21) Appl. No.: 09/940,966

(22) Filed: Aug. 29, 2001

(51) Int. Cl. H01F 27/28

(52) U.S. Cl. 336/195

(57) ABSTRACT

The multiple concentric coil wattage converter is a non-conventional type of concentric, closely wound coil component, that can be applied to either increasing voltage or amperage, or a combination of both, as required by each specific load application.

The multiple concentric coil wattage converter does not depend on standard A.C. transformer theory and practice in which a primary input winding induces a corresponding electromotive force in a single, or multiple secondary output windings over iron transformer laminations.

The multiple concentric coil wattage converter functions entirely due to Oersted's magnetic flux, by the intimate and continuous coil-to-coil magnetic flux transfer.

From a single primary winding in elongate form, it is expected that as many as eight or ten concentric secondary coils may be practical.

It is established that that a combination of increasedd amperage and voltage will be available, depending on how the secondary coils-end terminals are connected to each other, in symmetrical pairs, or group.

The multiple concentric coil wattage converter will work on either D.C. or A.C input to the primary coil.

### BACKGROUND OF THE INVENTION

Standard alternating current (A.C.) transformer technology has been well established over the decades, and is a highly efficient means of transforming the A.C., either up or down depending on the specific load requirements.

The use of flat silicon steel laminations has proven to be the best, cost-effective means of A.C. waveform transfer from the primary to the secondary winding(s), with a minimum of losses and high degree of reliability.

Standard A.C. transfer efficiencies are known to be quite high, in the 90% to 95% efficiency range, which is ideal for all small, mid and large size commercial applications.

Most standard small A.C. transformers use the closed, squarish lamination iron form so that the primary insulated windings are on one side of the core, opposite from the secondary windings for convenient fabrication and manufacturing purposes. Since the primary and secondary windings usually fill the center core volume, this arrangement meets the needs for convenient winding spacing allocation.

In some later, more advanced transformer designs, some useful designs have been introduced in the area of multiple secondary winding concepts.

In particular, the transformer art of M. Cobb (1994) and P. Jensen (1994) have proposed and evolved such multiple secondary windings, on the same basic lamination cores.

There is a particular useful factor in the Cobb design, which disclosed the winding of the secondary(s) in the opposite hand direction to the primary winding. Such an opposite hand in the secondary(s) causes an increase in the reluctance in the primary winding, and thus becomes an energy conservation means for the transformer unit

Although this reluctance factor is not high, over time it can make a considerable reduction in the watt/hour flow rate through the primary windings.

It is not presently known what progress is being made towards the production of such improved multiple secondary coil transformer, but they are most certainly needed in view of the growing electrical energy crisis, both here and worldwide. Inventors such as M. Cobb and P. Jensen havve started a trend towards advanced conventional transformers for commercial usage.

### BRIEF SUMMARY OF THE INVENTION

The present multiple coil wattage converter is unique in the class, since it does not depend on standard transformer type electromanetic A.C. induction acting on flat iron laminations betweeen sets of primary and secondary insulated coils.

This new wattage converter concept is based on the application of Oersted's magnetic flux in which a helical magnetic flux is produced directly around an insulated electrical conductor as an electromotive force is passed through it.

This method of magnetic induction between adjacent coil windings is very effective due to the close proximity of the adjacent coil wires, and the fact that this close and intimate contact is throughout the entire length of all the coil wiring, from the primary coil layer, and throughout all of the secondary coils.

It is presently believed that a maximun number of ten concentric secondary coil windings over a single primary coil is about the limit of secondary coil windings. Preliminary tests have shown there is no electromagnetic force losses at the firsr secondary coil, and it is expected that the losses throughout all of the subsequent coil layers of secondary windings will be progressively small.

Due to the large number (10) of secondary windings, it is expected that there will be a heat build-up throughout the coils, which may present an operational problem at some point.

One solution to this possible overheating problem will be to wind all of the secondary coils in equal sections of about 8 windings, with equal gaps in between them of about 3 to 4 wire width wide, in order to circulate air flow within these gaps, or heat sinks. Such vertical gaps should provide sufficient air flow through them to remove any excessive heat build-up from the coil assembly.

Considering that the secondary coil heights will probably be about one inch high, these gaps should provide the means to keep the secondary coil temperature within acceptable levels.

With this multiple number of secondary coil windings, the total combination of voltage and amperage level combinations becomes flexible and adaptable for a fair range of load applications.

As an example, with an input primary rated at 6 volts D.C. at 2 amperes, the output from all the secondaries could be:

1) 12 volts, at 16 amperes

2) 24 volts, at 8 amperes

3) 110 volts, at about 1.3 amperes.

Although this type of multiple coil wattage converter can only increase wattage output, and not decrease it, as conventional transformers can, this feature is seen as a positive factor in view of the increasing need for electrical power supply.

The various voltage and amperage combinations are obtained by connecting the end terminals from each layer of coils into either, series or parallel circuits, or combinations of both, as per standard electrical circuitry procedures.

Another design feature in this multi-coil converter concept is the addition of thin buss wire (Sn—Cu) tinned-copper wire to increase the effectiveness of the magnetic flux distribution between the adjacent conductor coil windings. This buss wire augmentation method has been tested and found to be helpful in increasing the magnetic flux through the coils of stranded wire conductor coils.

A Disclosure Document which describes portions of this multiple coil wattage converter has been filed with the USPTO and returned, date stamped Jun. 13, 2001, with file No.495134.

### BRIEF DESCRIPTION OF THE SEVERAL VIEWS OF DRAWING

FIG. 1 is a side elevation view of the multiple wattage converter.

FIG. 2 is an end view of the multiple wattage converter.

FIG. 3 is a partially enlarged local side section view showing the vertical air gaps.

FIG. 4 is a partially enlarged local side section view showing the interposed buss wire windings between the conductor coils.

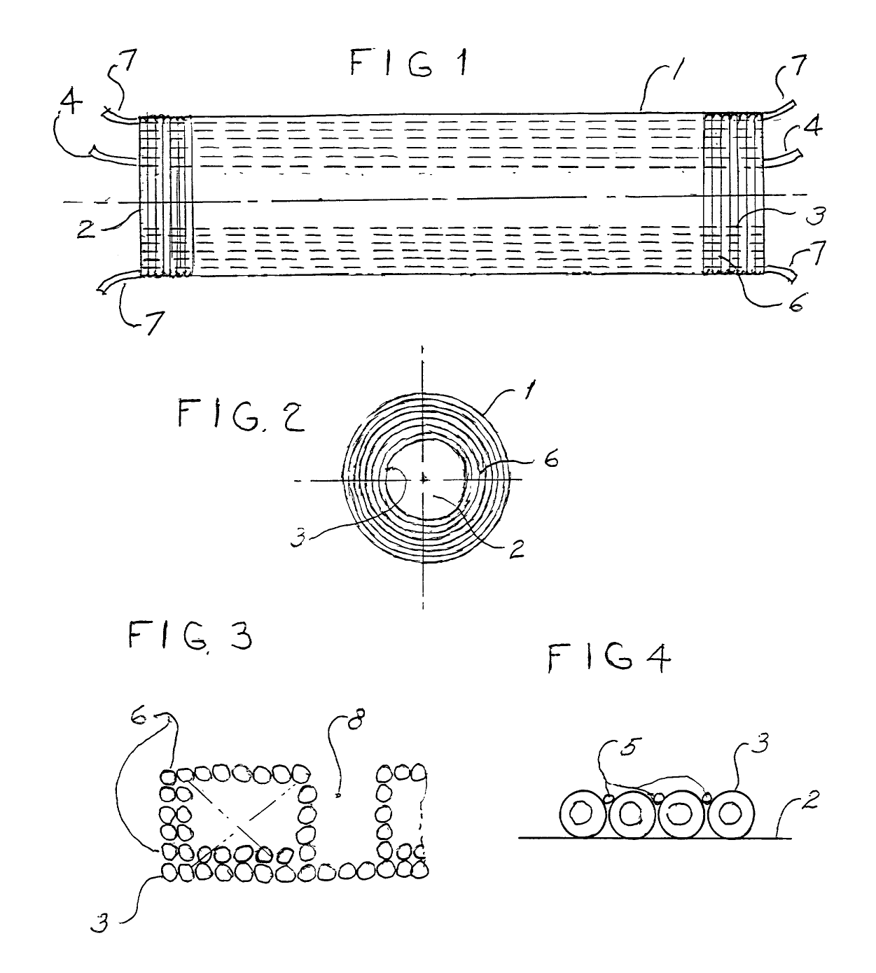

### DETAILED DESCRIPTION ON THE INVENTION

The multiple coil wattage converter 1, is comprised of a hollow steel or plastic core piece 2, on which a continous primary widing 3, is wound. The core piece 2, is an elongated cylindrical form, with a diameter to length ratio of approximately 1:10, so that the number of coil turns is at least 125 for an adequate ampere turns ratio.

The primary coil 3, is the first coil layer on the core piece 2, and has two end leads, or pigtails 4, for connection to the electromagnetic force source.

Fine tinned-copper wire is wound over the primary coil 3, over its full length with no end connections.

The first secondary coil 6, is wound directly over the primary coil 3, from one end of the core 2, to the other end. These secondary coils 6, also have two end leads 4 at both ends for connection to a load, or other secondary windings 6.

Each subsequent secondary winding (6) is wound directly over the previous secondary winding 6, with the interposed buss wire 5, in place, as in the first primary coil 3, case.

There may be as many as ten secondary coils 6, concentrically wound over the first primary coil 3, for a maximun wattage output.

The end connection 7, from each secondary coil 6, may be made in any series/parallel coil connection combination, as previously described, and must always be balanced and symmetrical, as required by logical electrical engineering standards.

Due to the possibility of coil assembly overheating, uniformly wide air gaps 8, may be required within all of the secondary coil 6, layers. These air gaps 8, are approximately 3 to 4 wire widths wide, and will be vertical from the first secondary coil 6 layer to the top layer.

I claim:

1) A multiple coil wattage converter comprised of a single primary winding over a full cylindrical core, multiple secondary windings directly wound over each other, and over the first, single primary windings.
end wire connection leads protruding from each secondary and primary coil.
fine buss wire wound between the said primary and secondary windings from one end of the said cylindrical core to the other end with no end connections.

2) A multiple coil wattage converter according to claim 1, in which said secondary coils are magnetically induced to produce an electromagnetic force from the single said primary winding by means of Oersted's magnetic flux surrounding any electrical conductors, said magnetic flux is transferred to each and every said secondary coil within said multiple coil wattage converter.

3) A multiple coil wattage converter according to claim 1, wherein uniform air flow gaps are located in all of said secondary windings,
such air flow gaps are approximately 3 to 4 wire widths wide, with the uniform coil groups being about 8 wire widths wide
free air flow means surrounding such said multiple coil wattage converters.

4) A multiple coil wattage converter according to claim 1, in which all of the said secondary windings are connected in a combination of all or partial series and/or parallel circuits in a balanced and symmetrical pattern.

5) A multiple coil wattage converter according to claim 1, in which the preferred electrical input is direct current from any convenient source
alternating current (A.C.) is also an acceptable form of electrical input,
the wattage output always increases from coil level to the next higher coil level, and never decreases as in conventional iron-core transformers.
